(19) United States
(12) Patent Application Publication
(10) Pub. No.: US 2020/0125704 A1
(43) Pub. Date: Apr. 23, 2020

(54) DEVICE UTILIZATION MONITORING AND PREVENTION OF UNSOLICITED ACTIVITIES

(71) Applicant: Avaya Inc., Santa Clara, CA (US)

(72) Inventors: David Chavez, Broomfield, CO (US); Pushkar Yashavant Deole, Pune (IN); John Alexander Young, Buntingford (GB); Yolanda Del Toro, Broomfield, CO (US)

(21) Appl. No.: 16/165,298

(22) Filed: Oct. 19, 2018

(51) Int. Cl. G06F 21/32; G06N 3/02

(52) U.S. Cl. CPC G06F 21/32; G06N 3/02

(57) ABSTRACT

Embodiments of the disclosure provide a communication system and method. In one example, the communication system is disclosed to include a communication device configured for use by a primary user and a borrowing user, where use of the communication device by the primary user is governed by primary user permissions, and where use of the communication device by a borrowing user is governed by borrowing user permissions. The illustrative system is further disclosed to include computer memory having a set of user binding instructions that, when executed by a processor, enable establishment of a binding relationship between the communication device and the primary user and, so long as the binding relationship between the communication device and the primary user is maintained, enable use of the communication device to be governed by the primary user permissions instead of the borrowing user permissions.

### FIELD OF THE DISCLOSURE

Embodiments of the present disclosure relate generally to communication methods and communication devices.

### BACKGROUND

Today, smartphone use and communication device use, in general, has prevailed among younger generations. Many parents give smartphones to their children and don't really care or understand how the smartphone or communication device is used by their children. Once the children have access to the device, they can use the parents' account, many times downloading and launching various types of games or applications that the parent does not otherwise want on their device and/or might pose a risk to the child. Another problem is that the child could, inadvertently, authorize payments or approve certain types of financial transactions when they have possession of their parents' device.

In other scenarios, the device owner could lend the device to someone else for temporary use or the device could be used by someone else without the owner's knowledge while the device is in unlocked state. In this case, the device owner's identity is potentially at risk of being stolen by the other person who is using the device.

### BRIEF SUMMARY

Passwords and biometric security solutions do not necessarily solve the afore-mentioned issues. For example, many uses of a communication device by someone other than the owner are actually permitted by the owner. Additionally, it is becoming increasingly easier to steal a person's password or spoof a person's biometric information. Embodiments of the disclosure solve these and other issues by providing a binding method between a primary user of a communication device as well as other binding methods with borrowing users of the communication device. A communication device as used in this context can be a desktop, smart phone, laptop, softphone application on a laptop or desktop computer, iPad, wearable device (e.g., Apple watch or Fitbit), or any other software or hardware used to communicate with other applications where a password and login may or may not be necessary to allow access to one or more applications on the device.

In some embodiments, a primary user or owner of a communication device can have their identity/persona bound with their communication device. As a non-limiting example, a system operating on the communication device may be provided with an embedded set of activity monitoring instructions. This particular set of activity monitoring instructions may be activated whenever the display of the communication device is switched on and activated to facilitate use thereof.

Whenever someone is using the communication device, the activity monitoring instructions may enable the communication device to record how the user interacts with the device (e.g., including but not limited to determining 1) an angle with which the device is usually held, 2) finger size, 3) whether the device is being operated with left hand/right hand/combination of both hands, 4) whether the user manipulates the input with some or all of their fingers, 5) key pressure applied on the device display, 6) cadence between keystrokes, 7) changes to language/locale/time zone set by the user, or 8) changes to Wi-Fi points to which the device is usually connected, etc.).

This activity information can be used in the computations of parameters to determine a behavior profile for the primary user of the communication device in addition to determining behavior profile(s) for borrowing users or other users that are not the primary user. In addition to the behavior profile and device usage heuristic parameters, a biometric recording module in the device or separately communicating with the device may record one or more of the primary user's physical biometrics such as fingerprints, finger size, facial size and face recognition, voice recognition, other vital signatures, such as, blood pressure, eye retina scan, etc. The biometric recordings may be continuously recorded as the primary user's physical biometrics change over time just as the primary user's heuristics are recorded over time to provide improved data used to compute the confidence scores. Likewise, a borrowing user's biometrics and heuristics may be recorded once or over time to improve the data used to compute the confidence scores.

One or more of these physical biometric recordings may be considered primary parameters that form the user's identity and a combination of the user's behavior profile along with device usage heuristics (non-limiting examples described above) which work as secondary or supporting parameters may be used to determine and confirm the user's identity. In such case, the primary user can be identified using one of the physical biometrics with a high confidence and a secondary parameter may be used in embodiments to achieve a higher level of confidence so that spoofing is prevented.

In some embodiments, the biometric recording module may be intelligent enough to augment the biometric information configured by the user and further enhance the biometric information. For example, the primary user may have configured fingerprints as the biometric recording, however the biometric recording module monitors and records additional biometrics such as facial scan, voice samples, etc., and then automatically augments the user's identity with additional biometrics after a sufficient period of device usage that allows the module to determine with confidence that the biometrics that are recorded automatically are indeed of the primary user.

In some embodiments, the behavior or device usage heuristics may prevail over the physical biometric parameters (e.g., in case the user is using device in a dark room where his face could not be recognized and biometrics could not form a high confidence score). Or in the case of a borrowing user operating the device using fingers of primary user (e.g. when the primary user is in an unconscious state; or in case of child, the parent is sleeping and child uses the fingers of parent to operate the device), the physical biometric information would match completely (if the primary user's fingerprint was the only biometric recorded) or the biometric would match partially (if facial scan is additionally recorded); however, the primary user's heuristic information or behavioral information would not match causing the confidence score to decrease. Similarly, if the physical biometric cannot identify the primary user (e.g., primary user's facial scan is the only recorded biometric, and the device and the user is in dark room where the comparison to a current scan and recorded scan fails), then the primary user's behavior based on device usage heuristic would be used to compute the confidence score. In this case the borrowing user's access may be blocked if the borrowing user accesses applications having more restrictive policies controlling access thereto. Additionally, a notification may be sent to the primary user.

Such secondary information can be continuously updated using machine learning mechanisms to help adjust and modify the behavior profile(s) for any user of the communication device, whether a primary user or borrowing user. Eventually as the behavior profile(s) become robust enough and contain an appropriate amount of data, the behavior profile(s) can be used to determine, with a particular confidence score or index, an identity of the user that is currently using the communication device. In some embodiments, the determination may simply correspond to a decision of whether or not the primary user is using the communication device or the determination may further help identify regular or repeat borrowing users of the communication device.

In some embodiments, an activity monitor providing activity monitoring instructions may be used to track various types of activities performed on the communication device. Non-limiting examples of such activities include e-commerce purchases, email utilization, text message activity, device location information, social media feeds (e.g., Facebook, WhatsApp messages, etc.), apps/games/websites the user visits mostly, and so on. In some embodiments, the primary user may be required to grant permission to the activity monitoring instructions to enable access to all this personal information during profile setup.

In some embodiments, the activity data obtained during activity monitoring may be recorded and uploaded (e.g., in encrypted form) by the communication device to remote server/cloud storage. This may help to further establish the pairing/binding between the primary user and the communication device. In some embodiments it may be possible to assume that the user that is using the device for the first time (e.g., after it is initially powered on) may not be the owner/primary user of the device, but rather is an administrator/user helping the primary user carry out the device setup and configuration on primary user's behalf. The activity monitoring instructions may be configured to understand this scenario and, hence, would capture several samples of data before establishing/activating the device-to-owner pairing/binding. As can be appreciated, as more and more activity data is accrued, the more accurate and stronger the pairing/binding can be made between the primary user and the communication device.

Embodiments of the present disclosure may also enable the communication device or the activity monitoring instructions to identify if the user of the communication device is an adult or a non-adult by recording the finger size, fingerprints, facial recognition of user to identify the face size, facial expressions, etc. and compare all this captured data with various samples stored for different age groups.

In some embodiments, the activity monitoring instructions may use either the biometrics usage data or Artificial Intelligence data (e.g., any type of data model built upon known or tested biometric data), if enabled by user. The selection of a particular approach may depend upon which method yields more accurate results. Alternatively, a combination of approaches may be utilized to make the determination as to whether the current user of a device is the primary user or a borrowing user.

In some embodiments, the communication device may be configured to prompt the primary user to complete a one-time registration (e.g., after the device is powered on for the first time), which could include providing the user's identity (e.g., thumb impression, fingerprint information, facial image samples, etc.) and some personal information about the user (e.g., email id, unique identity number, username, etc.) which would then be uploaded by the communication device to a remote server/cloud storage system in an encrypted format. This may not be a mandatory process for the primary user and primary user may choose to do it for additional security (e.g. the email id or username configured by the user during registration could be used to send notifications about device activity). Even if the one-time registration process is not formally completed by the primary user, embodiments of the present disclosure may still provide a pairing/binding between the primary user and the communication device and that pairing/binding may be configured to dynamically modify over time and as the communication device continues to be utilized. In some embodiments, after a pairing/binding between the primary user and the communication device is established, the activity monitoring instructions may be further configured to generate and store a footprint (e.g., descriptive metadata) of the binding information on local memory of the communication device for quick access and basic comparison functions.

Embodiments of the present disclosure further contemplate that various usage policies may be provisioned and enforced for different types of users of the communication device. For instance, a primary user may be allowed to configure different policies for themselves as well as for one or more borrowing users during registration or after the pairing/binding has been effectuated between the primary user and the communication device. These various policies may include any number of usage policies related to permissions, restrictions, access levels, available functions, hidden functions, etc. One or more policies may also be defined or provisioned by a borrowing user, perhaps subject to permissions granted by the primary user. As some non-limiting examples, the different types of policies may include a definition of types of applications that are made accessible to borrowing users (e.g., educational applications, music applications, child entertainment applications, etc.) and some applications that are not made accessible to borrowing users (e.g., primary user's social media applications, personal email and/or work email application). In some embodiments, the policy could include an age definition (e.g., if the borrowing user is a non-adult, then access to apps/games that are beyond the child's age are prevented and the child is not allowed to purchase anything online or to provide any personal information to applications). The policy could also be configured to govern that access to any financial type of applications (e.g. Wallet, Paytm, banking mobile applications, etc.) would be prevented. Additionally, the owner could configure a policy where access to social networking applications such as Facebook, Twitter, WhatsApp, etc. would be prevented when the communication device is being used by a borrowing user or some other non-primary user.

One or more other customized policies could also be applied such as, in case of a child accessing the smartphone, the communication device could be configured to prevent the child from downloading/accessing one or more defined games/applications for the child but could also redirect the child to another game/application that is more appropriate based on the policy configuration.

Embodiments of the present disclosure also contemplate enabling the communication device to automatically enforce and react to violations of utilization policies. As a non-limiting example, when a borrowing user is using the device and the activity monitoring instructions cannot make a determination of whether or not the current user is the primary user (e.g., based on the biometrics footprint or a lack of confidence in the comparison of the current user against known users of the system), then the communication device may attempt to leverage an Artificial Intelligence system to compare the data related to typical usage of the device such as applications, websites visited, email, messages sent, social media feeds, e-commerce purchases etc. and compare this information with information being recorded in the current session. This comparison may be used to identify that the pairing/binding between the smartphone and primary user is broken or still remains intact. This comparison may not be immediate and may involve some time lag since the AI system may need some time to capture the usage activity of current user, who may or may not correspond to the primary user. Such as in the scenario where another person gets access to the smartphone, either with or without the knowledge of the primary user (e.g., a parent has given his smartphone to a child or the child/other person has got the device while it was in unlocked state or the device has been taken by child/other person and unlocked by stealing the owner's identity). The primary user may give permission and login information to enable the borrowing user to momentarily access various types of content, but if the system determines that the user has changed from the primary user to a borrowing user, then the pairing/binding between the primary user and communication device may be broken and permissions associated with the borrowing user rather than the primary user may be referenced for functionality of the communication device. In this case, the borrowing user may have the device for a longer time period than originally intended. The system may determine it is best to switch to permissions associated with the borrowing user (only allow specific restricted actions) and send a notification to the primary user that the borrowing user still has the device. If the borrowing user cannot be identified, then the system may determine is it best to switch to permissions that greatly restrict applications access and hide the fact that a notification was sent to the primary user. As part of registration the primary user may register: 1) additional contact information for alternative devices, such as, a work number, cell phone, and home phone number; or 2) contact information for alternative communication applications, such as, email addresses (work or personal); or 3) social media accounts, such as, Twitter so that notifications can be sent to the primary user without the borrowing user's knowledge. In some embodiments, the notifications may be sent to the primary user's alternative device, sent to applications on the device that the borrowing user is restricted from using, or notifications may be displayed on the dashboard/home screen of the device hidden from the borrowing user using the device and visible only after the primary user starts operating the device again.

In some embodiments, the AI system may utilize heuristics to baseline the sites a primary user is likely to visit or purchase from, usage patterns of a primary user (or borrowing user), contacts of the primary user (or borrowing user), the primary user's response profile for emails and texts, etc. For example, by reviewing the context of the text messages or emails that have been sent, the AI system may determine whether the content of the message is or is not similar to how the primary user writes/responds to messages. As a specific, but non-limiting example, the primary user may compose text messages in full sentences whereas the primary user's child, in this case the borrowing user, may write in slang, consistently use emojis or pictures in all of the child's text and email messages. This difference in usage patterns may be recognized by the activity monitoring instructions and/or with the help of the AI systems. As another example, the borrowing user may have a login for a particular social media outlet (e.g., Snapchat) whereas the primary user does not. In this scenario, the primary user is unlikely to access a Snapchat account with the communication device and this information may be used to determine that a binding between the primary user and the communication device has been broken if the user activity indicates an attempted access to the social media website or application. In another example, the activity monitoring module may determine the recipient of a current communication is not a direct contact of the primary user, but a contact of the borrowing user if the recipient is not listed in the primary user's profile or perhaps from information obtained from other sources. Such information is available if the primary user enables the sharing of information from the primary user's profile on social media (Facebook, Twitter), the device contacts information, or a service plan, such as, a friends and family telephone plan, then the activity monitor can use this information to determine whether a recipient of a message is a primary user's friend, a permitted borrowing user, or the device is hacked.

In all above cases, when the primary user, borrowing user (e.g., child) begins using the device, the activity recording instructions may be configured to record the usage pattern (either biometric or AI or combination of both) and search for a mismatch with the data footprint stored on the device and the pairing/binding between the communication device and the primary user gets broken. After the paring/binding between the device and the primary user is broken, the activity monitoring instructions may cause the communication device to activate a policy compliance set of instructions and, possibly at the same time, send a notification to the primary user that can be delivered via some mechanism other than the communication device. The policy compliance instructions may be configured to load all of the policies configured by the primary user and possibly other policies provided by a borrowing user. When a user first attempts to access a new website, game, or application, the policy compliance instructions may further check if any of the configured policies allow/disallow such an action and take appropriate recourse (e.g., block the access or redirect the user to another website/application), thereby preventing the borrowing user from violating the policies.

Embodiments of the present disclosure also contemplate mechanisms for notifying a primary user when a borrowing user is violating a use policy and/or when a binding between the primary user and the communication device has been broken. In some embodiments, the activity monitoring instructions could include a constrained set of instructions that specify mechanisms for notifying the primary user regarding a use attempt that violates a policy defined by the primary user. The policy could also specify what should be the content of the notification, whether the details of application/game/website to which the access was attempted or download was attempted.

Alternatively or additionally, the policy could specify a notification with the screenshot of the communication device and a frequency at which the notification should be sent with the screenshot, which may be configured to resemble the monitoring of device activity by the primary user in near-real time.

In some embodiments, the primary user could also configure a policy regarding what action to take on the notification (e.g., the policy could block/prevent access or might allow access to the borrowing user for some time (configurable)). This would be useful when the primary user himself/herself has handed over the device to a trusted borrowing user to carry out some activity on the primary user's behalf. In this case, instead of removing the already configured policies, the primary user could simply change the policy regarding the action to be taken on detection of the attempt and allow the borrowing user access for some predetermined amount of time. In some embodiments, the activity monitoring instructions may be configured to record inappropriate activity of the borrowing user in its local database and may decide to put the notifications on the dashboard/home screen of the communication device when it detects that the device is not being used by the borrowing user anymore but, rather, is being used by the primary user (e.g., the next time primary user takes control of the communication device).

One aspect of the present disclosure provides a communication system that includes:

a communication device configured for use by a primary user and a borrowing user, wherein use of the communication device by the primary user is governed by primary user permissions, and wherein use of the communication device by a borrowing user is governed by borrowing user permissions; and

computer memory comprising a set of user binding instructions that, when executed by a processor, enable establishment of a binding relationship between the communication device and the primary user and, so long as the binding relationship between the communication device and the primary user is maintained, enable use of the communication device to be governed by the primary user permissions instead of the borrowing user permissions.

Another aspect of the present disclosure provides a method that includes:

configuring a communication device for use by a primary user or a borrowing user;

establishing a binding relationship between the communication device and the primary user in response to determining that the primary user has physical custody of the communication device and is currently interacting with a user interface of the communication device;

determining whether to maintain or break the binding relationship between the communication device and the primary user; and

enabling use of the communication device to be governed by primary user permissions instead of borrowing user permissions so long as the binding relationship between the communication device and the primary user is maintained.

### BRIEF DESCRIPTION OF THE DRAWINGS

FIG. 1A is a block diagram illustrating components of a system according to one embodiment;

FIG. 1B is a block diagram depicting a first user in possession of a communication device in accordance with at least some embodiments of the present disclosure;

FIG. 1C is a block diagram depicting a second user in possession of the communication device in accordance with at least some embodiments of the present disclosure;

FIG. 1D is a block diagram depicting a third user in possession of the communication device in accordance with at least some embodiments of the present disclosure;

FIG. 2 is a block diagram illustrating components of a communication device according to embodiments of the present disclosure;

FIG. 3 is a block diagram depicting a data structure used in connection with securing a communication device according to embodiments of the present disclosure;

FIG. 4 is a flow diagram depicting a method of pairing a primary user with a communication device in accordance with at least some embodiments of the present disclosure;

FIG. 5 is a flow diagram depicting a method of pairing/binding a borrowing user with a communication device in accordance with at least some embodiments of the present disclosure;

FIG. 6 is a flow diagram depicting a method of monitoring user behavior and controlling communication device functionality based thereon in accordance with at least some embodiments of the present disclosure;

FIG. 7 is a flow diagram depicting a method of modifying communication device functionality based on adult versus non-adult utilization thereof in accordance with at least some embodiments of the present disclosure;

FIG. 8 is a flow diagram depicting a method of storing binding information in accordance with at least some embodiments of the present disclosure; and

FIG. 9 is a flow diagram depicting a method of controlling communication device functionality in accordance with at least some embodiments of the present disclosure.

In the appended figures, similar components and/or features may have the same reference label. Further, various components of the same type may be distinguished by following the reference label by a letter that distinguishes among the similar components. If only the first reference label is used in the specification, the description is applicable to any one of the similar components having the same first reference label irrespective of the second reference label.

### DETAILED DESCRIPTION

In the following description, for the purposes of explanation, numerous specific details are set forth in order to provide a thorough understanding of various embodiments disclosed herein. It will be apparent, however, to one skilled in the art that various embodiments of the present disclosure may be practiced without some of these specific details. The ensuing description provides exemplary embodiments only and is not intended to limit the scope or applicability of the disclosure. Furthermore, to avoid unnecessarily obscuring the present disclosure, the preceding description omits a number of known structures and devices. This omission is not to be construed as a limitation of the scopes of the claims. Rather, the ensuing description of the exemplary embodiments will provide those skilled in the art with an enabling description for implementing an exemplary embodiment. It should however be appreciated that the present disclosure may be practiced in a variety of ways beyond the specific detail set forth herein.

While the exemplary aspects, embodiments, and/or configurations illustrated herein show the various components of the system collocated, certain components of the system can be located remotely, at distant portions of a distributed network, such as a LAN and/or the Internet, or within a dedicated system. Thus, it should be appreciated, that the components of the system can be combined into one or more devices or collocated on a particular node of a distributed network, such as an analog and/or digital telecommunications network, a packet-switch network, or a circuit-switched network. It will be appreciated from the following description, and for reasons of computational efficiency, that the components of the system can be arranged at any location within a distributed network of components without affecting the operation of the system.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics, and may take the form of acoustic or light waves, such as those generated during radio-wave and infra-red data communications.

As used herein, the phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising,” “including,” and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

The term “computer-readable medium” as used herein refers to any tangible storage and/or transmission medium that participate in providing instructions to a processor for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, and EPROM, a FLASH-EPROM, a solid state medium like a memory card, any other memory chip or cartridge, a carrier wave as described hereinafter, or any other medium from which a computer can read. A digital file attachment to e-mail or other self-contained information archive or set of archives is considered a distribution medium equivalent to a tangible storage medium. When the computer-readable media is configured as a database, it is to be understood that the database may be any type of database, such as relational, hierarchical, object-oriented, and/or the like. Accordingly, the disclosure is considered to include a tangible storage medium or distribution medium and prior art-recognized equivalents and successor media, in which the software implementations of the present disclosure are stored.

A “computer readable signal” medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, RF, etc., or any suitable combination of the foregoing.

The terms “determine,” “calculate,” and “compute,” and variations thereof, as used herein, are used interchangeably and include any type of methodology, process, mathematical operation or technique.

It shall be understood that the term “means” as used herein shall be given its broadest possible interpretation in accordance with 35 U.S.C., Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary of the disclosure, brief description of the drawings, detailed description, abstract, and claims themselves.

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Any combination of one or more computer readable medium(s) may be utilized. The computer readable medium may be a computer readable signal medium or a computer readable storage medium.

In yet another embodiment, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the disclosed embodiments, configurations, and aspects includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

Examples of the processors as described herein may include, but are not limited to, at least one of Qualcomm® Snapdragon® 800 and 801, Qualcomm® Snapdragon® 610 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARIVI926EJS™ processors, other industry-equivalent processors, and may perform computational functions using any known or future-developed standard, instruction set, libraries, and/or architecture.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as program embedded on personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Embodiments of the disclosure provide systems and methods for persona-based presentation services, either from a mobile network core or directly from an application operating on a communication device being carried by a caller (calling party) or called party associated with a call. While the flowcharts will be discussed and illustrated in relation to a particular sequence of events, it should be appreciated that changes, additions, and omissions to this sequence can occur without materially affecting the operation of the disclosed embodiments, configuration, and aspects.

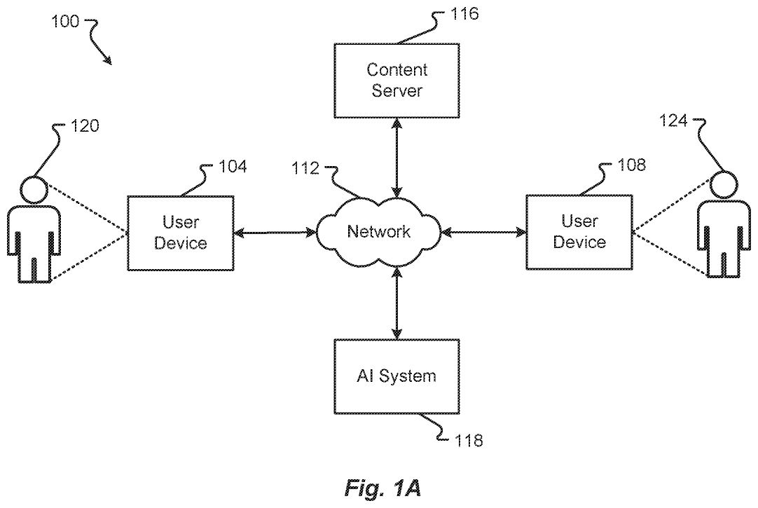

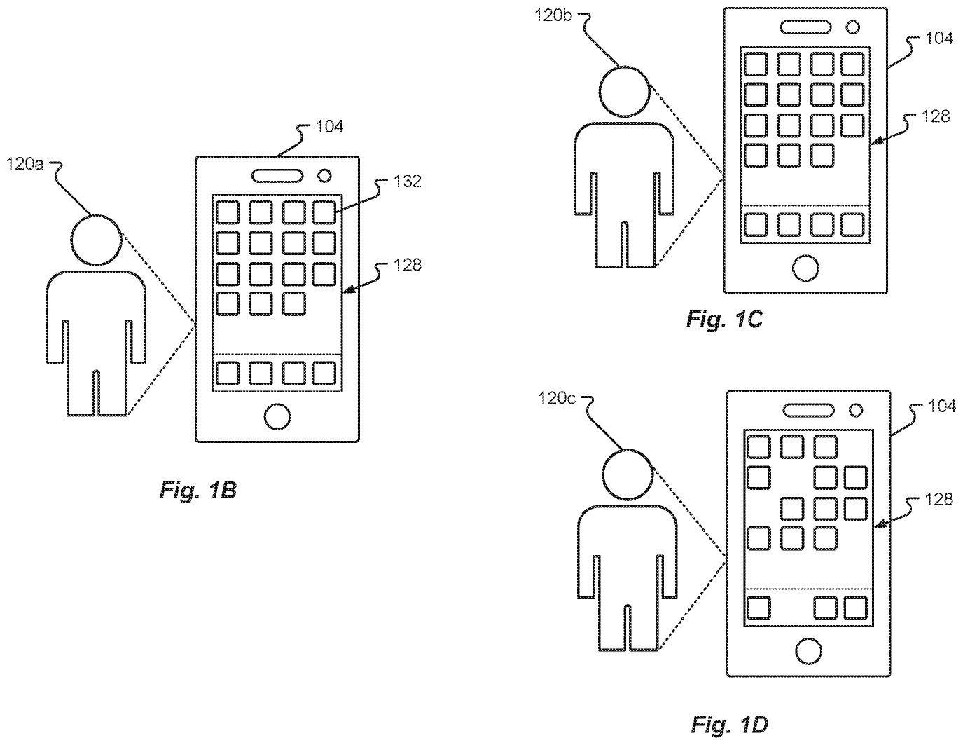

With reference now to FIG. 1, an illustrative communication system 100 will be described in accordance with at least some embodiments of the present disclosure. As shown in FIG. 1, the system 100 may include a first communication device 104 and second communication device 108 in communication with one another via a communication network 112. In one non-limiting embodiment, one or both communication devices 104, 108 may correspond to mobile communication devices (e.g., smartphones, tablets, wearable devices, etc.) that are carried by users 120, 124 respectively. In such a scenario, the communication devices 104, 108 may be in communication with one another through one or more mobile networks, that may be operated by one or more mobile network operators (MNOs). Accordingly, the network 112 may include a cellular or other wireless network and the communication devices 104 and/or 108 can include smartphones, tablets, laptop computers, wearable devices, or any other portable electronic device configured to communicate over the network 112. It should be understood that while only two devices 104, 108 are illustrated here for the sake of simplicity, any number of devices of different types may be connected with the network 112 at any given time.

The network 112 can also include an Internet Protocol (IP) Multimedia Subsystem (IMS) framework providing Internet and/or other data services to the communication devices 104, 108 over the network 112. Generally speaking, the IMS framework of the network 112 can utilize Session Initiation Protocol (SIP) and/or other Internet Engineering Task Force (IETF) standard protocols to provide any number of IP multimedia services including but not limited to Voice over IP (VoIP) calling, video, media streaming, web access, etc. Alternatively or additionally, the network 112 may include a distributed computing network such as the Internet or some other packet-based communication network.

The communication system 100 may further include one or more content servers 116 and an AI system 118 that are also in communication with the network 112. In some embodiments, the one or more content servers 116 may be provided by one or multiple servers that are in communication with the network 112. As a more specific example, the content server(s) 116 may provide one or both communication devices 104, 108 with web-based content (e.g., HTML files) and/or application-specific content that is specifically formatted for viewing within an operating system of the user device 104, 108. It should be appreciated that various types of content provided by content servers 116 may be limited or prohibited for certain types of users (e.g., borrowing users, non-adult users, etc.) based on one or more policies maintained in a user device 1084, 108 by the primary user.

The Artificial Intelligence (AI) system 118 may include one or multiple servers that are configured to analyze behaviors of users 120, 124 on their respective user devices 104, 108 and, based on such analyzed behaviors, determine whether a particular user corresponds to a primary user or a borrowing user. In some embodiments, the AI system 118 may be embedded in the primary user's device as one of the applications or services on the primary user's device. In some embodiments, the AI system 118 may include or have access to a plurality of different user behavior models that define a particular or expected behavior for primary user or adult user. In other embodiments, the AI system 118 may have access to or maintain user-specific behavior models and help to determine whether a particular user is currently using a device or whether a different (e.g., borrowing user) is using a device. Additional functionality of the AI system 118 will be described below.

FIGS. 1B thru 1D depict usage scenarios for a user device 104. Although the various usage scenarios will be described in connection with user device 104, it should be appreciated that similar or identical scenarios can be applied to user device 108 or any other user device. In some embodiments, as shown in FIG. 1B, a first user 120a, which may also be referred to herein as a primary user 120a, may correspond to an owner/operator of the user device 104. In particular, the primary user 120a may be a user that has purchased the user device 104 or has been administered with a full set of usage privileges for the user device 104. Because the primary user 120a corresponds to the controlling owner or user of the device 104, the primary user 120a may be enabled to interact with the device 104 to a fullest extent allowed by the functionality of the device 104. For instance, the primary user 120a may be allowed to view all content on the user interface 128 of the device 104 and may further have access to and usage privileges/permissions for any and all applications stored on the device 104. Thus, a full compliment of application icons 132 may be presented to the primary user 120a via the user interface 128 when the primary user 120a is determined to be in possession of and currently using the user device 104. As will be discussed in further detail herein, when it is determined that the primary user 120a is in current possession of and using the user device 104, a usage binding may be established between the primary user 120a and the user device 104. In the event that the primary user 120a hands the device 104 to a different user (e.g., a borrowing user 120b, 120c) or user 120b takes the device 104 from unsuspecting user 120a while the device 104 is unlocked, then the usage binding previously established between the primary user 120a and the user device 104 may be broken. The breaking of the usage binding may result in various functions or features of the user device 104 being disabled for the borrowing user 120b, 120c or until the primary user 120a is determined to come back into possession of the user device 104.

As shown in FIG. 1C, it may be possible for a second user 120b (e.g., a first borrowing user 120b) to have full access to features and functions of the user device 104. In other words, some borrowing users, such as the first borrowing user 120b, may be allowed to have usage permissions of the user device 104 that are similar or identical to the usage permissions of the primary user 120a. In such a scenario, the full compliment of icons 132 for all applications on the user device 104 may still be presented to the first borrowing user 120b even though the binding between the primary user 120a and the user device 104 has been broken. In such a scenario, a second binding may be established between the first borrowing user 120b and the user device 104 (similar to the binding between the primary user 120a and the user device 104) to maintain the full features and functions for the first borrowing user 120b. If this binding is broken and the binding is not re-established with the primary user 120a, then functionality of the user device 104 may be limited, modified, or otherwise disabled.

As shown in FIG. 1D, a second borrowing user 120c may not be provided with access to the full functions or features of the user device 104 as the primary user 120a or the first borrowing user 120b. In some embodiments, the second borrowing user 120c may correspond to a different user that is not an adult user or that is not fully trusted by the primary user 120a such that the primary user 120a limits the capabilities of the user device 104 when the device is handed to or in the possession of the second borrowing user 120c. In some embodiments, the second borrowing user 120c may not be able to view or access certain applications stored on the user device 104. In such a situation, the icons 132 for those applications may not be presented on the user interface 128, the icons may be presented but the borrowing user may see an error message on selection of those icons, or these applications at least may not be selectable by the second borrowing user 120c. In some embodiments, the second borrowing user 120c may not be able to access certain types of content (e.g., particular content servers 116 or web addresses) using a browser of the user device 104 even though the second borrowing user 120c has the ability to access the browser of the user device 104. Alternatively or additionally, the second borrowing user 120c may not have access to certain functions of the user device 104 that are provided by the operating system (e.g., texting functions, calling functions, etc.). Additional details of the mechanisms that can be employed to limit such functions of the user device 104 when the second borrowing user 120c is in possession of the device 104 will be described in further detail herein. In some embodiments, the AI system 118 may be configured to track and record some or all of the borrowing user's actions and the primary user may receive notification after the borrowing user accesses certain applications as per the borrowing user's policies as administered by the primary user. In some embodiments, the logic responsible for tracking and reporting such activities to the primary user may be locally-executed at the communication device 104, 108 rather than being provided by the AI system 118, as will be discussed in further detail herein. In some embodiments, a set of AI instructions executed on the communication device 104, 108 may be provided in combination with the separate AI system 118. In such a configuration, the AI instructions on device would be capable of operating on its own (e.g., autonomously), while in other embodiments, the AI instructions would connect with the AI system 118 as part of its operation.

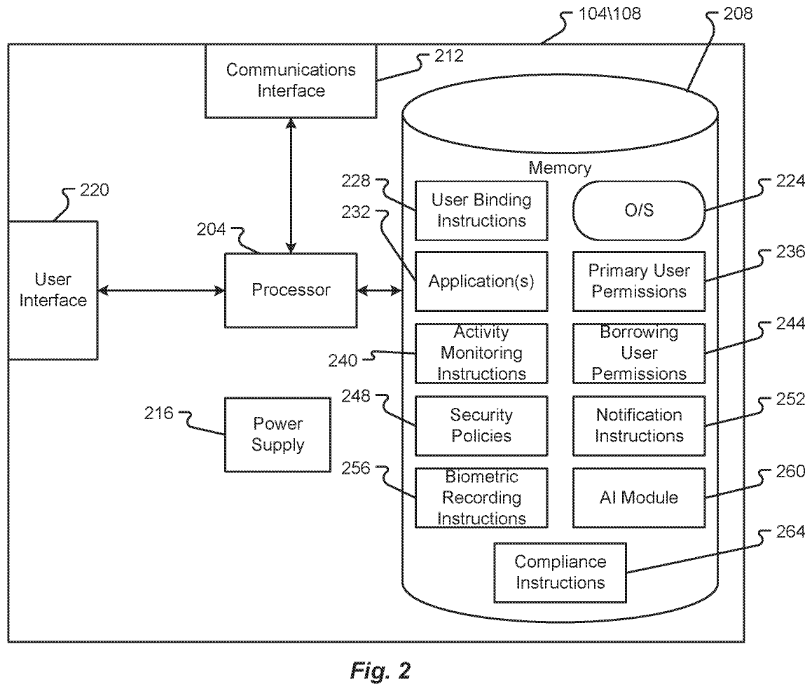

With reference now to FIG. 2, additional details of a communication device 104, 108 will be described in accordance with at least some embodiments of the present disclosure. Although the devices 104, 108 are referred to generally as communication devices, it should be appreciated that the communication device(s) 104, 108 may correspond to mobile communication devices, wearable communication devices, computers, laptops, tablets, Personal Digital Assistants (PDAs), etc.

The communication device 104, 108 is shown to include a processor 204, memory 208, a communication interface 212, a power supply 216, and a user interface 220. In some embodiments, all of the components of communication device 104, 108 are provided within a common device housing and are connected via a one or multiple circuit boards. In an alternative embodiment, the AI module 260 may communication with a cloud service to store data and execute AI computations.

The processor 204 may correspond to one or multiple processing circuits. In some embodiments, the processor 204 may include a microprocessor, an Integrated Circuit (IC) chip, an ASIC, or the like. The processor 204 may be configured with a plurality of logic circuits or circuit elements that enable the processor 204 to execute one or more instructions or instruction sets maintained in memory 208. Alternatively or additionally, the processor 204 may be configured to execute instructions for operating the communications interface 212 and/or user interface 220. As an example, the processor 204 may be configured to execute one or more drivers that are specifically provided for the communications interface 212 and/or the user interface 220.

The memory 208 is shown to be in communication with the processor 204. The memory 208 may include any type or combination of computer memory devices. Non-limiting examples of memory 208 include flash memory, volatile memory, non-volatile memory, RAM, NVRAM, SRAM, ROM, EEPROM, etc. As can be appreciated, the types of devices used for memory 208 may depend upon the nature and type of data stored in memory 208.

In the depicted embodiment, the memory 208 includes one or a plurality of finite/closed-ended instruction sets that are executable by the processor 204. Non-limiting examples of instruction sets that may be provided in memory 208 include an operating system (O/S) 224, user binding instructions 228, application(s) 232, primary user permissions 236, activity monitoring instructions 240, borrowing user permissions 244, security policies 248, notification instructions 252, biometric recording instructions 256, an AI module 260, and compliance instructions 264.

A user of the device 104, 108 may be enabled to access and utilize the applications 232 via use of the O/S 224. Examples of an O/S 224 include Apple iOS, Android OS, Blackberry OS, Windows OS, Palm OS, Open WebOS, etc. In some embodiments, the O/S 224 provides a display of icons that are presented via the user interface 220. Some or all of the icons may be selectable by the user of the communication device 104, 108 to access routines or features provided by applications 232. In some embodiments, each application 232 has a specific icon associated therewith that is presented via a home screen of the O/S 224. When that specific icon is selected by a user, the user interface 220 of the communication device 104, 108 may present specific data and graphics associated with the application.

The user binding instructions 228 may comprise instructions that enable creation of a binding between a user of the device 104, 108 and that further enable the determination of when such a binding has been broken. As used herein, a binding may represent a logical association between a particular user and a particular device 104, 108 corresponding to a point in time or a period of time during which the particular user is determined to be in physical possession of the device 104, 108 and using the device 104, 108. A binding may be broken when that particular user no longer has physical possession of the device 104, 108 and/or when another user is detected as interacting with the user interface 220, regardless of whether or not the particular user is within possession (or a predetermined proximity) of the device 104, 108. In some embodiments, the binding instructions 228, when executing by the processor 204, may enable the processor 204 to determine when a particular user (e.g., a primary user 120a or a borrowing user 120b, 120c) is in physical possession of the device 104, 108 and when that particular user is utilizing the particular device 104, 108. A user may be considered to be utilizing the device 104, 108 when the O/S 224 is operational/functional and/or when one or more applications 232 are being actively executed by the processor 204 and/or when the user is interacting with the device through user interface 220 either by physical touch or voice commands. Active execution of an O/S 224 and/or application 232 may result in certain types of data being rendered via the user interface 220 and/or transmitted via the communications interface 212.

The application(s) 232 may correspond to any type of executable instruction set that causes the device 104, 108 to perform certain predetermined actions or that enable the user of the device 104, 108 to access one or more hardware components of the device 104, 108. In some embodiments, the application(s) 232 may include any type of communication application, chat application, calling application, email application, social media application, gaming application, finance application, digital media streaming application, shopping application, web browser, geolocation application, navigation application, music application, video application, etc.

The primary user permissions 236 and borrowing user permissions 244 may correspond to a set of rules, parameters, policies or the like that control a particular user's ability to access hardware components of the device 104, 108 and/or a particular user's ability to utilize applications(s) 232 or the O/S 224, in general. In some embodiments, the primary user permissions 236 correspond to a set of rules, policies or parameters that are applied to utilization of the device 104, 108 when a binding exists between the primary user 120a and the device 104 (e.g., as shown in FIG. 1B). In some embodiments, the primary user 120a may be enabled to fully access all functions, applications, and hardware of the device 104, 108. This may not necessarily be the case if the primary user is identified as a minor and the minor's parents/guardians impose one or more limitations on the minor's use of the device 104, 108 or the device is shared between numerous primary user's as is the case when nurses share a smart phone on their 24 hour shift (a first nurse uses the device from midnight to 8 am, a second nurse uses the same device from Sam to 4 μm and a third nurse uses the same device from 4 μm to midnight but none of the nurses want the other nurses to see their personal email messages or phone messages); otherwise, the primary user will likely have more device functionality available to them as compared to any other borrowing user. The device functionality may be controlled with the O/S 224 referencing whether or not a primary user 120a is currently bound to the device 104, 108 and then referencing the associated primary user permissions 236 for the primary user 120a. Reference to the user permissions 236 may be done at each instance of the primary user 120a inputting an instruction to the device 104, 108 or at least instance of the primary user 120a attempting to access a new application or function of the device 104, 108.

The borrowing user permissions 244, on the other hand, may correspond to a set of rules (e.g., policies), parameters, or the like that control the borrowing user's 120b, 120c ability to access hardware components of the device 104, 108 and/or utilize particular application(s) 232 or the O/S 224. Much like the primary user permissions 236, the O/S 224 may reference the user binding instructions 228 to determine if a binding between the primary user 120a and the device 104, 108 has been broken. If the binding is broken between the primary user 120a and the device 104, 108, then the O/S 224 may operate the device 104, 108 based on a set of borrowing user permissions 244. The borrowing user permissions 244 may include a set of default borrowing user permissions as well as a set of user-specific permissions that are associated with known and enrolled borrowing users 120b, 120c. This default borrowing user permissions may specifically be used when the user binding instructions 228 do not recognize a current user of the device 104, 108 as a known or enrolled borrowing user. In some embodiments, user-specific permissions may be the same as default permissions, but such a configuration is not required. In some embodiments, the borrowing user permissions 244 may enable the O/S 224 to determine what types of hardware components and application(s) 232 a borrowing user is allowed to access within the device 104, 108. In some embodiments, if the borrowing user 120b, 120c corresponds to a known and enrolled user, then the user binding instructions 228 may determine that a binding exists between the borrowing user 120b, 120c and the device 104, 108 until such time as another user is detected to be using the device 104, 108, thereby breaking the binding between the borrowing user 120b, 120c and the device 104, 108.

The activity monitoring instructions 240 may correspond to a set of instructions that, when executed by the processor 204, enable the processor 204 to analyze particular usage of the device 104, 108. The activity monitoring instructions 240 may include instructions that monitor usage patterns of the application(s) 232, the O/S 224, or hardware components of the device 104, 108. For instance, the activity monitoring instructions 240 may be provided with access to one or more hardware sensors of the device 104, 108 (e.g., fingerprint scanners, camera, touch screen, microphone, accelerometers, etc.). The activity monitoring instructions 240 may also receive usage information associated with an application 232 or O/S 224 (e.g., particular commands received at the application 232 or O/S 224 or usage statistics associated with operation of a particular application 232 or O/S 224). As a non-limiting example, the activity monitoring instructions 240 may be configured to determine whether a particular user is inputting data (e.g., typing) with a particular frequency or speed, determine whether a particular user is actively using particular applications, receive biometric information from the user, request the user to input an access code or password, determine that certain functions are being performed within an application, determine that certain features (e.g., text features, calling features, social media features, etc.) are being utilized by an application, and so on. The information from the activity monitoring instructions 240 may be provided to the user binding instructions 228 (e.g., as inputs to routines or as called variables for the user binding instructions 228) to enable the user binding instructions 228 to determine whether a user/device binding is valid, should be maintained, should be created, should be broken, etc.

The security policies 248 may correspond to general usage or access permissions associated with the device 104, 108. As compared to primary user permissions 236 and borrowing user permissions 244, the security policies 248 may not necessarily be associated with a particular user (either primary user or borrowing user). Rather, the security policies 248 may correspond to global usage policies or rules that are enforced by the O/S 224, regardless of whether or not a device/user binding exists and regardless of whether the device 104, 108 is determined to be utilized by a primary user or borrowing user. Examples of security policies 248 may include, without limitation, network access policies, Internet access policies, display policies, sound policies, privacy policies, sound and haptics policies, etc. In some embodiments, the various security policies 248 may be enforced on top of any permissions 236, 244 that are enforced by the O/S 224 or application(s) 232. Thus, if a security policy 248 conflicts with a permission 236, 244, then the security policy 248 may be enforced instead of enforcing the conflicting permission 236, 244.

The notification instructions 252 may correspond to a set of instructions that, when executed by the processor 204, enable the processor 204 to generate and send notifications to a particular user or predefined address. The notifications generated and sent by the notification instructions 252 may include any type of message or alert for a primary user to notify the primary user that a binding has been broken as determined by the user binding instructions 228. For instance, the primary user 120a may specify that they desire to receive a notification at an alternative device (e.g., a device other than their device 104, 108) when a binding is broken between themselves and the device 104, 108. The primary user 120a may also use the notification instructions 252 to specify when a notification is generated and transmitted indicating that an unknown borrowing user is utilizing the device 104, 108 as compared to a known and enrolled borrowing user. In some embodiments, such a notification may also be sent to an application host to terminate an application connection and ensure an application is no longer accessible since the binding is broken, such as the case when a borrowing user may be accessing the primary user's mobile banking application on the device. In some embodiments, the notification instructions 252 may also specify certain actions that a device 104, 108 takes or an alternative device takes that the primary user controls (e.g., flashing a light, displaying a green light when a binding is active or red light when a binding is broken, generating a sound with a speaker, sending an email or message etc.) when a binding is broken or, perhaps, when a binding is active or created (e.g., as a positive assertion that a binding exists).

The biometric recording instructions 256, when executed by the processor 204, may enable the communication device 104, 108 to actively or passively monitor various biometrics inputs of a user of the device. In some embodiments, the biometric recording instructions 256 may be configured to automatically, but in a background process that is not visible to the user, capture one or more images of the user to determine whether the current user is a primary or borrowing user or, in some embodiments, to build or update biometric templates for the user. In some embodiments, the biometric recording instructions 256 may passively capture voice inputs from the user, again as part of determining whether the user is a primary user or borrowing user or, in some embodiments, to update voice biometric templates for the user. In some embodiments, the biometric recording instructions 256 may be configured to cooperate with the activity monitoring instructions to create a combination of biometric recorded data and behavioral recorded data. The combination of biometric recorded data and behavioral recorded data may be provided to a locally-executed set of AI instructions, in the form of the AI module 260, to determine whether a current user of the device 104, 108 is a primary user or a borrowing user. In some embodiments, the AI instructions 260 may be configured to identify or attempt identification of a user with the combination of biometric recorded data and behavioral recorded data. For instance, the AI instructions 260 may be configured to first analyze behavioral recorded data and determine if the behavioral recorded data matches a primary user's behavioral heuristic information within a predetermined confidence. If so, then the AI instructions 260 may simply determine that the current user is the primary user. If the behavioral recorded data does not match the primary user's behavioral heuristic information within the predetermined confidence, then the AI instructions 260 may go on to match biometric recorded data with a biometric template for the primary user. Meanwhile, if the AI instructions 260 determine that the current user is a primary user, then the AI instructions 260 could continue recording data and building models of behavior for the primary user for later use.

The compliance instructions 264, when executed by the processor 204, may enable the communication device 104, 108 to abide by the rules/policies 248 configured for the device when the binding between the device and the primary user is active. Alternatively or additionally, the compliance instructions 264 may be configured to enable the communication device 104, 108 to abide by the rules/policies 248 when the binding between the device and the primary user is broken. Alternatively or additionally, the compliance instructions 264 may be configured to enable the communication device 104, 108 to abide by particular sets of rules/policies 248 when the binding between the device and a known borrowing user is active.

The communications interface 212 provides hardware and drivers that enable the device 104, 108 to connect with the network 112, receive communications from the network 112, and/or provide communications to the network 112 for delivery to another communication device. In some embodiments, the communications interface 212 includes a wired and/or wireless network adapter. Non-limiting examples of a communications interface 212 include an antenna and associated driver (e.g., a WiFi or 802.11N antenna and/or driver), an Ethernet card and/or driver, a serial data port (e.g., a USB port) and/or driver, a Bluetooth or BLE antenna and/or driver, an NFC antenna and/or driver, or any other type of device that facilitates inter-device communications. The communications interface 212 may receive one or more data packets or messages from the communication network 112 and extract data therefrom. The data extracted from the received data packets or messages may be provided to the processor 204 where the data can subsequently be processed using instructions stored in memory 208.

The power supply 216 may correspond to an internal power source and/or adapter for connection with an external power source. In the example of an internal power source, the power supply 216 may correspond to a battery or cell of batteries used to power the various other components of the device 104, 108. Alternatively or additionally, the power supply 216 may include a power converter or power conditioner that enables power received from an external source (e.g., a 120V AC power source) to be converted into useable DC power that can be supplied to the various components of the communication device 104, 108.

The user interface 220 may correspond to a user input device, a user output device, a combination user input/output device, or a number of such devices. As an example of a user input device, the user interface 220 may include a microphone, a button, a physical switch, a camera, an accelerometer, or the like. As an example of a user output device, the user interface 220 may include a speaker, a light, a display screen, a tactile output device (e.g., a haptic feedback device), or the like. As an example of a combination user input/output device, the user interface 220 may include a touch-sensitive display screen that has one or more areas thereof capable of presenting a Graphical User Interface (GUI) element and, if touched or selected by a user, recognizing that the GUI element has been selected by the user.

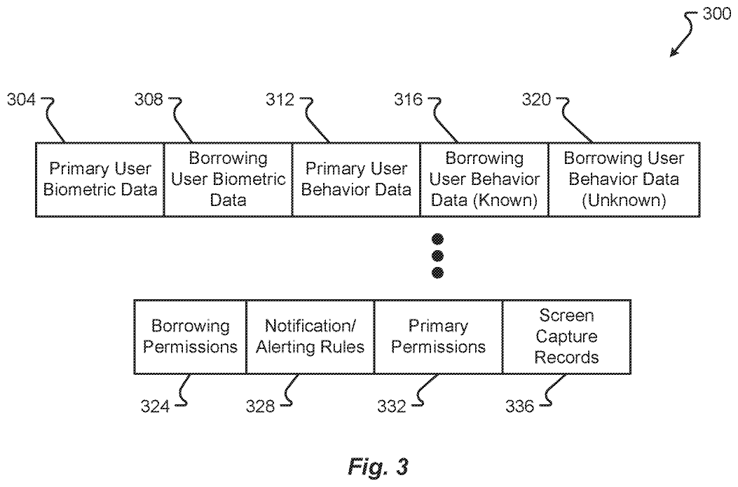

With reference now to FIG. 3, additional details of a data structure 300 that can be used to detect and enforce user binding instructions 228 and/or activity monitoring instructions 240 will be described in accordance with at least some embodiments of the present disclosure. The data structure 300 is shown to include a number of data fields, which may be stored in any number of possible computer memory devices. For instance, the fields of the data structure 300 may be stored in memory of a user device 104, 108, in memory of the AI system 118, or in combinations thereof. For instance, some of the data fields may be maintained in the user device 104, 108 whereas others of the data fields may be maintained in the AI system 118. It may also be possible that instance of a data field are maintained in both the device 104, 108 and the AI system 118.

The illustrative data fields that may be included in the data structure 300 include, without limitation, a primary user biometric data field 304, a borrowing user biometric data field 308, a primary user behavior data field 312, a borrowing user behavior data field for known users 316, a borrowing user behavior data field for unknown users 320, a borrowing user permissions field 324, notification/alerting rules 328, a primary permissions field 332, and a screen capture records field 336. Likewise, there may be one or more additional data structure 300 for each multiple borrowing users to store their biometric data. The one or more additional data structure 300 may collect different data and include different data fields.

The borrowing user permissions field 324 may be similar or identical to the borrowing user permission 244 depicted and described in connection with FIG. 2. Similarly, the notification/alerting rules 328 may be similar or identical to the notification instructions 252 depicted and described in connection with FIG. 2. Alternatively, the notification/alerting rules 328 may correspond to a rule set or parameters that a user is allowed to configure and that are inputs to the notification instructions 252. Said another way, the notification/alerting rules 328 may correspond to a data set whereas the notification instructions 252 may correspond to executable instructions that utilize the notification/alerting rules 328.

The biometric data fields 304, 308 may contain any type of biometric data for known and enrolled users of the device 104, 108. In some embodiments, enrolled users may only correspond to primary users of the device 104, 108. In other embodiments, one or more enrolled users may correspond to known and trusted borrowing users of the device 104, 108, perhaps who have a predetermined relationship with the primary user. The primary user biometric data 304, as the name suggests, may include biometric templates, descriptions of biometric features, or any other biometric information uniquely associated with the primary user 120a. The borrowing user biometric data 308, on the other hand, may include biometric templates, descriptions of biometric features, or any other biometric information uniquely associated with a known and enrolled borrowing user. The borrowing user biometric data 308 may also include biometric information for unknown borrowing users, but may not correspond to a full set of biometric data as with the biometric data for known and enrolled borrowing users. The types of biometric data that may be referenced within the data fields 304, 308 include, without limitation, facial biometric data, fingerprint biometric data, favored hand biometric data, voice biometric data, retina biometric data, gesture biometric data, and any other type of known biometric data.

The behavior data fields 312, 316, 320 may correspond to data fields for storing and updating user behavior data or behavior data models along with parameters used to drive the data models including the heuristic parameters. The data models may correspond to any type of data models usable within the AI system 118 or derivatives of such models. In some embodiments, the primary user behavior data field 312 may be used to store information that describes an expected, predicted, normal, or similar set of behaviors for the primary user 120a. The behaviors may be described in terms of application utilization, communication functionality utilization, messaging preferences (e.g., the list of names in the primary user's contacts or list of friends in social media accounts or list of individuals in the family's Friends and Family telecom account), grammatical behaviors, message composition behaviors (e.g., sentence structure, extensive use of short forms, use of slang words, frequency of emoji utilization, common spelling mistakes, etc.), combinations thereof, and the like. In embodiments where more than one primary user are designated for a device 104, 108, then user behavior data for each primary user may be stored within the primary user behavior data field 312. The data may be represented as basic set of data from a single data source (e.g., a single application, the O/S 224, from a single sensor, etc.), as a combination of data from different sources (e.g., from multiple applications, from multiple sensors, etc.), as a computational model that is useable within the AI system 118 (e.g., as an artificial neural network, a feedforward neural network, a regulatory feedback neural network, a recurrent neural network, a modular neural network, a dynamic neural network, etc.).

The borrowing user behavior data fields 316, 320 may also be used to store data models or derivatives thereof that are useable within the AI system 118. In some embodiments, the fields 316, 320 may be combined into a single field with an indicator that identifies a borrowing user as either a known or unknown user. The types of data or data models stored within the fields 316, 320 may be similar to the types of data or data models stored within the primary user behavior data field 312, except that the data or data models may be associated with borrowing user's 120b, 120c, whether known or unknown. The data models maintained in these fields 316, 320 may be static or dynamic. Dynamic data models may be updated from time-to-time depending upon whether observed user behaviors continue to occur outside the definition of stored models and if such user behaviors are identified as valid by a user (e.g., the primary user 120a).

The primary permissions field 332 may be used to store information related to device use permissions created by the primary user and/or that are to be imposed on the primary user. In some embodiments, the primary permissions field 332 may be used to store permissions defined by a primary user for application to a borrowing user. The primary permissions field 332 may be similar to the primary user permissions 236 and/or borrowing user permissions 244.

The screen capture records field 336 may be used to store data captured by the activity monitoring instructions 240 and/or biometric recording instructions 256. As a non-limiting example, the activity monitoring instructions 240 may be configured to capture images of the screen of the device 104, 108 at predetermined intervals. The screen capture records field 336 may be used to store those captured screen images (e.g., as an image document or the like). More specifically, in some embodiments, the screen capture records field 336 may store a collection of screen shots captured at configured intervals, up to a predetermined number of screen shots, in order to send the captured snapshot to the primary user to allow him/her to monitor the device activity in near-real-time. Thus, even if the primary user is okay with a borrowing user having possession of the device 104, 108, the primary user may receive periodic updates of the borrowing user's activity vis-à-vis the screen capture images stored in the field 336, which may be shared with the primary user at the time of capture or at a later point in time.

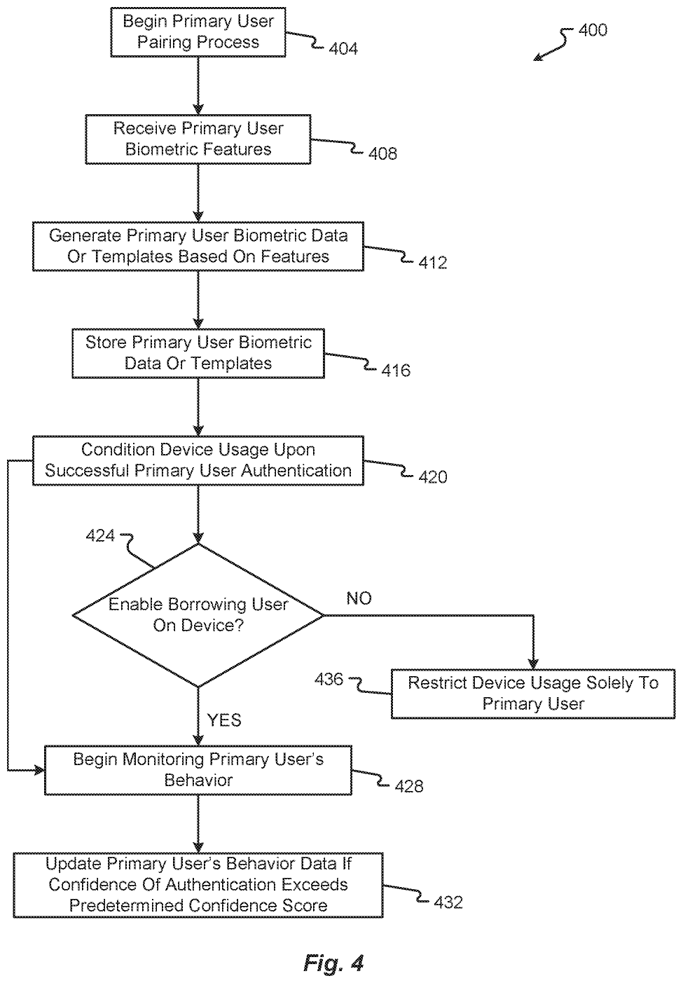

With reference now to FIG. 4, a method 400 of enrolling/pairing a primary user 120a for use with a device 104 will be described in accordance with at least some embodiments of the present disclosure. The method 400 may be performed by the processor 204, within the AI system 118, or by a combination thereof. It should be appreciated that while the method 400 is described in connection with enrolling a single user as a primary user, that the steps of the method 400 may be performed for one or multiple primary users, even if multiple primary users are associated with a single device 104.

The method 400 begins with a primary user of the device 104 initiating use of the device 104 and engaging a primary user into a pairing or binding process (step 404). This may occur automatically through use of the device 104 through sufficient use of the device that would build sufficient level of confidence score for binding/pairing to occur) or the primary user may be guided through a particular binding process which requires the primary user to answer one or more questions, perform one or more actions with the device 104, and so on. Increased and continued use by the primary user and borrowing user of the device should allow the AI module 260 and/or the binding instructions 228 to compute with a high level of confidence scores that predicts whether the current user is the primary user or a borrowing user including an unknown user. The monitoring instructions 240 and compliance instructions 264 gather a sufficient level of data and heuristic parameters to drive the AI models maintained by the AI module 260 and/or AI system 118.

The method 400 will continue with the device 104 receiving one or more biometric features of the primary user (step 408). The biometric features may be captured with one or multiple sensors or input devices of the device 104. Alternatively or additionally, sensors or input devices that are external to the device 104 may be used to capture biometric features of the primary user. In some embodiments, the biometric features may include one or more facial images of the primary user, one or more retinal images of the primary user, one or more fingerprint images of the primary user, one or more voice samples of the primary user (e.g., repeating a predetermined phrase or word sequence), one or more gesture samples of the primary user, and so forth.

Based on the received biometric information, the method 400 continues by generating primary user biometric data (step 412). In some embodiments, the primary user biometric data may be stored as one or more biometric templates within the data structure 300. For instance, the primary user biometric data field 304 may be updated to include the biometric templates generated based on the biometric features of the primary user (step 416).

The method 400 then continues by conditioning the device's utilization upon a successful authentication of the primary user (step 420). The authentication of the primary user may include an initial authentication process whereby the primary user initially provides input(s) to the device 104 to activate the device and unlock a home screen of the device. Additional ongoing authentication may also be required as part of step 420. In particular, a primary user may be continuously authenticated by their device 104 during their use of the device 104. This continuous authentication may correspond to the establishment of a binding condition between the primary user and the device 104, where the binding condition indicates that the primary user is still in physical possession of the device 104 and is the user that is actively using the device 104. The ongoing authentication may be performed by continuously or periodically monitoring the usage activity for the device 104 (e.g., via execution of the activity monitoring instructions 240) and then re-determining that the binding between the primary user and the device 104 is still valid.

In some embodiments, the primary user may define user permissions for conditions in which the binding between the primary user and the device 104 is broken (step 424). Specifically, the primary user may be allowed to enable or disable one or more borrowing users on their device. If the primary user does not enable borrowing users for their device, then the method 400 will proceed without developing any borrowing user data fields, and borrowing user permissions 244 may simply indicate that all features and functions of the device 104 are disabled or prevent others from using the device or accessing the applications on the device if the binding between the primary user and the device is broken (step 436).

If, however, the primary user enables one or more borrowing users to utilize their device 104, then additional methods may be performed even when the binding between the primary user and the device 104 is broken. Additional details of such a sharing scenario will be described more fully herein below. The method 400 may still continue while the primary user continues to utilize their device 104. Through ongoing usage of the device, the primary user's behavior patterns and statistics may be monitored via execution of the activity monitoring instructions 240 (step 428). As the primary user continues to use their device and the binding between the primary user and the device remain intact, then it may be possible to update the primary user's heuristic usage data within the data field 312 (step 432). In particular, as long as the binding instructions 228 determine that the primary user's binding with the device 104 is still intact, then observed behaviors of the primary user may be utilized to update or modify one or more of the data models that define the primary user's normal or expected behavior. In some embodiments, such updates may be conditioned upon a binding score determined by the binding instructions 228 exceeding some predetermined threshold of binding scores. For instance, thresholds may be defined with reference to confidence scores. If a user's monitored behavior is found to match existing behavior models within a predetermined confidence score (e.g., greater than 80% confidence of a match between the monitored behavior and existing behavior models), then the binding between the primary user and device may remain intact; however, updating the primary user's behavior data or data models associated therewith may require a higher confidence score (e.g., greater than 90% confidence of a match between the monitored behavior and existing models). Thus, it may be possible to maintain a binding between a primary user and the device without also updating the primary user behavior data or data models associated therewith. Although not depicted, steps 428 and 432 may be continuously or periodically re-executed as long as the binding between the primary user and the device 104 remains intact. It should also be appreciated that in steps 428 and 432, the AI instructions 260 may be configured to record device usage heuristic data of the current user and use the heuristic data in connection with continued decisions related to pairing/binding between the user and device. In some embodiments, the AI instructions 260, either alone or in cooperation with the AI system 118, may be configured to compute pairing/binding confidence scores and continuously store the pairing/binding confidence scores within the AI model(s) to help improve determinations of whether a current user corresponds to a primary user or borrowing user. This constant updating of user behavior models may be performed entirely within the AI instructions 260 or with the help of the AI system 118.

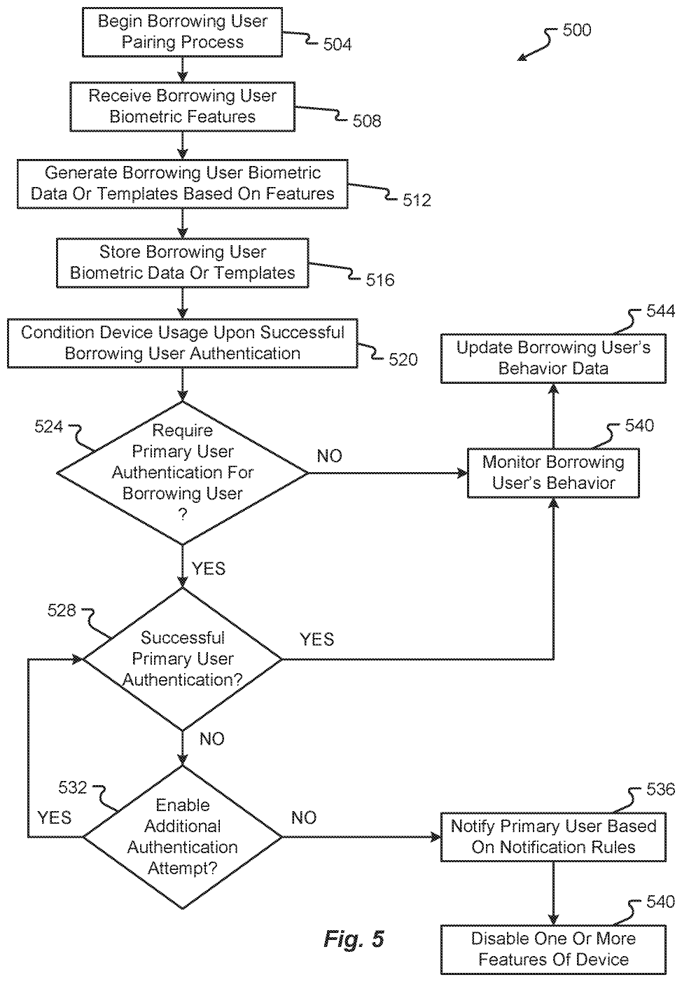

With reference now to FIG. 5, a method 500 of pairing a borrowing user with a device 104 will be described in accordance with at least some embodiments of the present disclosure. The method 500 begins with the initiation of a user pairing process (step 504). This particular step may be similar to step 404 except that it may be required that the pairing process is initiated by the primary user rather than being initiated by the borrowing user.

The method 500 continues by receiving biometric features of the borrowing user (step 508) and then generating a borrowing user biometric data or template based on the received features (step 512). These steps may be similar to step 408 and 412, but may require additional associations with a particular borrowing user as compared to generating biometric templates for primary users, which may not necessarily require a dedicated step of associating the biometric templates with the primary user.

The method 500 continues by storing the borrowing user data or templates within the data structure 300 (step 516). Thereafter, the device usage may be conditioned upon the borrowing user successfully authenticating themselves with the device (step 520). In some embodiments, the primary user may initially open or activate a device 104, which means that the primary user is initially bound to the device 104. However, if the primary user hands the device 104 to a borrowing user or if the borrowing user takes control of the device without approval (e.g., by stealing the primary user's identity), then the activity monitoring instructions 240 may detect the user is not the primary user and the binding between the primary user and the device 104 may be broken. Further usage of the device 104 may be conditioned upon the borrowing user establishing a separate binding with the device 104 and maintaining that binding with the device 104. Alternatively the policy compliance instructions 264 may start monitoring the user behavior to determine if such behavior is compliant with the policies for the borrowing user and if the borrowing user violates any such policy, whether or not the primary user is to be notified of the violation. It should be appreciated that the compliance instructions 264 may be integrated or made a part of the user binding instructions 228 without departing from the scope of the present disclosure.

In some embodiments, the primary user may be required to input additional permissions or authentication inputs (e.g., a borrowing-permitted input) to indicate that the borrowing user is allowed to borrow the device (step 524). If no further primary user inputs are required, then the borrowing user may simply be allowed to borrow the device unless and until their binding with the device is broken. To determine that the borrowing user's binding with the device remains intact, the method 500 may continue by monitoring the borrowing user's behavior (step 540) and possibly updating use behavior data associated with the borrowing user (step 544). In some embodiments, these steps may be similar to steps 428 and 432 such that a borrowing user's behavior data or data models are not updated unless the borrowing user's monitored behavior matches a behavior data model for that borrowing user within a predetermined confidence score.

Referring back to step 524, if additional inputs from the primary user are required to enable a borrowing user to utilize the device 104, then the method may continue by determining if the primary user has provided such required inputs so as to satisfy the additional authentication (step 528). In some embodiments, the primary user may be required to input a password or provide a biometric input to indicate their permission of allowing the borrowing user to utilize the device. In one embodiment, such input to grant permission to allow borrowing user to utilize the device, may be time bound or event bound, that is, the primary user allows the borrowing user to utilize the device for a limited amount of time or until a preconfigured event occurs such as the borrowing user trying to access an application the borrowing user is not supposed to do. If the primary user successfully provides such input, then the method 500 may continue to step 540. If the primary user does not successfully provide the required input, then the method 500 may continue by determining if another authentication attempt is permitted (e.g., if another try for authentication is allowed) (step 532). If this query is answered affirmatively, then the method 500 returns to step 528. If this query is answered negatively, then the method 500 may proceed by referring to the notification instructions 252 to determine if the primary user should be notified of the unpermitted use of the device 104 (step 536). If notification is desired or required, then the notification instructions 252 may be used to generate and send an appropriate notification to the primary user. In another embodiment, the notification to the primary user may be sent upon expiration of the borrowing user's time to use the device or occurrence of an event.

When a binding is broken, such as, in the scenario when no borrowing user is enrolled with the device, and as soon as an unenrolled borrowing user gets possession of the device, the pairing/binding between the primary user and device is broken. In this case, the method 500 may further include disabling one or more features or functions of the device 104 (step 540). For instance, the device 104 may be turned off or locked, thereby restricting the borrowing user from using any functions or features of the device 104. In other embodiments, the borrowing user permissions 244 may be referenced to determine if some features or functions of the device 104 are still allowed to remain active whereas other features or functions of the device 104 are disabled or hidden from view of the borrowing user. The device 104 may continue operating in this state until it is brought back into possession of the primary user and a proper binding is established between the primary user and the device 104.

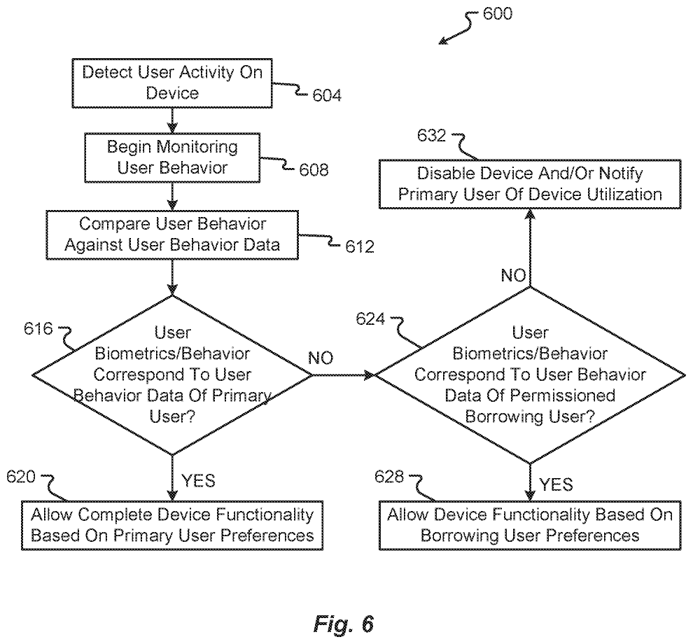

With reference now to FIG. 6, a method 600 of monitoring user behavior and controlling device functionality based thereon will be described in accordance with at least some embodiments of the present disclosure. The method 600 begins by detecting user activity on the device 104 (step 604). Such user activity may correspond to detecting a user input at the user interface 220 and/or detecting a change in state of the device via one or more sensors of the device 104 (e.g., by detecting the device has been lifted or moved based on outputs of an accelerometer, by detecting the device has been removed from a closed area based on outputs of an optical sensor, etc.).

Once user activity has been detected, the device 104 uses the primary user's biometric data to identify the user, but may find the data is insufficient to obtain a high confidence score thereby invoking the activity monitoring instructions 240 to begin monitoring the user behavior or usage characteristics of the device 104 (step 608). The monitored behavior or usage characteristics, at this point in time, may not necessarily be correlated to a known primary user or known borrowing user. Rather, the identity of the user may not currently be known by the device 104 (step 612). In other embodiments, a first step of user authentication may have already occurred prior to the initiation of the method 600 at step 604.

Based on the comparison of the user behavior against the user behavior data (e.g., some or all models stored in data fields 304, 312, 316, and/or 320), the method 500 continues by invoking the user binding instructions 228 to determine if the user behavior and/or biometrics currently monitored on the device 104 corresponds to biometrics and/or behavior data of the primary user (step 616). In some embodiments, this query may be answered positively if the observed behavior matches the behavior data of the primary user within a predetermined confidence level (e.g., greater than or equal to 80% confidence level for the match). If the query of step 616 is answered affirmatively, then the user binding instructions 228 determines that the current user of the device 104 corresponds to the primary user and the primary user is allowed to access functionality and features of the device 104 based on the primary user permissions 236 (step 620).

If the query of step 616 is answered negatively, then the method 600 may continue by determining if the monitored user behavior corresponds to user behavior data of a borrowing user (step 624). In particular, the user binding instructions 228 may compare the observed behavior data with one or more models maintained in data fields 316 or 320. Like the previous analysis at step 616, the analysis at step 620 may involve determining whether a predetermined confidence score is achieved during the comparison of the observed user behavior data with the stored behavior data models. If the query of step 624 is answered affirmatively, then the method 600 may continue by allowing the device 104 to be utilized based on the borrowing user permissions 244 (step 628). If, on the other hand, the query of step 624 is answered negatively, then the method 600 may proceed to disable the device 104 and/or notify the primary user of the unauthorized device utilization (step 632).

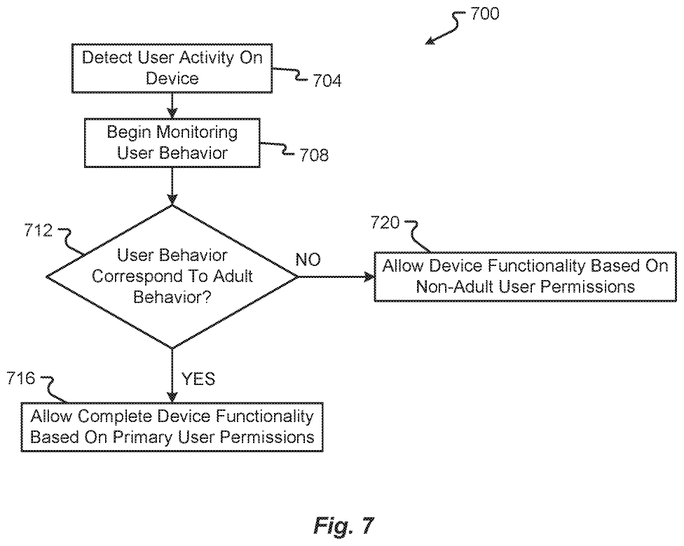

With reference now to FIG. 7, a method 700 of modifying device 104 functionality based on adult versus non-adult utilization thereof will be described in accordance with at least some embodiments of the present disclosure. This particular example may refer to a situation where a primary user is an adult user whereas a borrowing user is a non-adult user. The borrowing user in this scenario may or may not correspond to a relative of the primary user. The method 700 begins by detecting user activity on the device (step 704) and then monitoring the user behavior (step 708). These steps may be similar or identical to steps 604 and 608, respectively, depicted and described in connection with FIG. 6.

During the monitoring of the user behavior, the user binding instructions 228 may determine whether or not the observed user behavior corresponds to an adult behavior (step 712). In some embodiments, adult behavior may correspond to behavior or use of particular applications, certain message construction behaviors, or the like. For example, this step may involve detecting non-adult behavior as compared to detecting adult behavior. For instance, non-adult behavior may be detected by simply detecting a size of the user's finger as being more near a non-adult's finger size as compared to an adult's finger size. Other non-adult behaviors may include detecting a face size that is smaller than a predetermined size, detecting the user accessing particular applications, detecting certain message construction behaviors, message recipient is a child's known friends, etc.

If the user behavior is determined to correspond to adult behavior, then the device 104 may be allowed to complete any requested function or feature based on the primary user permissions 236 (step 716). On the other hand, if the observed behavior is determined to correspond to non-adult behavior (or not capable of positively being correlated to adult behavior), then the method 700 may continue with the device 104 limiting one or more functions made available to the non-adult user based on non-adult user permissions (step 720). In some embodiments, the borrowing user permissions 244 may correspond to non-adult user permissions although it may be possible to define non-adult user permissions within the primary user permissions without departing from the scope of the present disclosure.

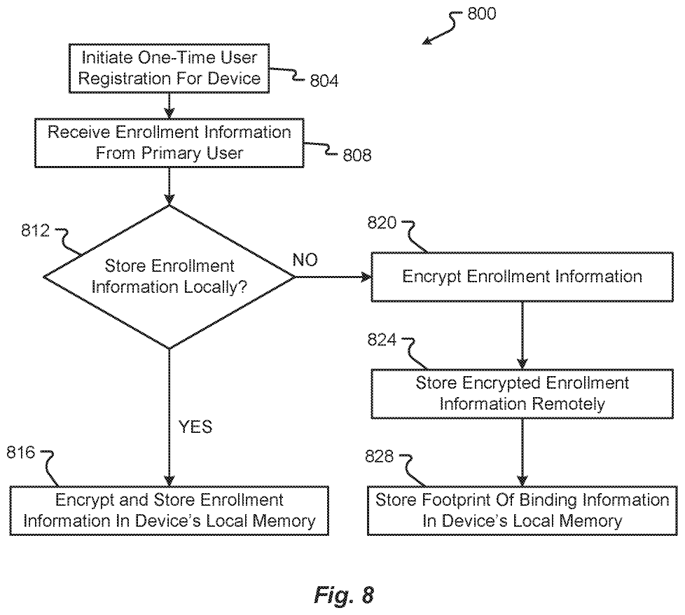

With reference now to FIG. 8, a method 800 of storing binding information will be described in accordance with at least some embodiments of the present disclosure. The method 800 begins by initiating a one-time user registration for the device (step 804). This particular step may be initiated by the primary user and, in some embodiments, may simply correspond to a single instance of a user enrollment process that may be automated or that includes one or more prompts for the user to follow. Although described as a one-time user registration process, it should be appreciated that this particular process may be performed multiple times (e.g., over time while the primary user uses the device) without departing from the scope of the present disclosure. Part of registering a primary user with a device 104 may include receiving certain types of enrollment information from the primary user (step 808). The enrollment information received from the primary user may include biometric information associated with the primary user, biometric data (e.g., fingerprints, facial scan, voice pattern, retina scan, etc. . . . ), user behavior data (during the initial enrollment and/or throughout the primary user's use of the device), user names, user passwords, PINS, or any other information that is useable to create or maintain a binding between the primary user and the device 104.

Before, during, or after enrollment information is received, the method 800 may continue by determining if the enrollment information is to be stored in local memory 208 of the device 104 or if the enrollment information (or models derived therefrom) is to be stored remotely (e.g., in memory of the AI system 118 or in a separate database) (step 812). If the query of step 812 is answered affirmatively, then the method 800 proceeds by encrypting and storing the enrollment information in the local memory 208 of the device 104 (step 816).

If, however, the query of step 812 is answered negatively, then the method 800 proceeds by enabling the processor 204 of the device 104 to encrypt some or all of the enrollment information (step 820). The encrypted enrollment information may then be transmitted to the AI system 118 or some other remote data storage location (step 824) (e.g., cloud storage or stored in a blockchain). In some embodiments, the encrypted enrollment information may be transmitted by the user device 104 over the communication network 112. In some embodiments, the method 800 may further store a footprint of binding information within the local memory 208 of the device 104 (step 828). In some embodiments, the footprint of the binding information may correspond to discrete data points from a larger data model stored remotely within the AI system 118. Alternatively or additionally, a footprint of the binding information may include lightweight versions of a biometric template that is stored in a more complete version at the AI system 118. It should be appreciated that the footprint of the binding information may also be encrypted prior to being stored in memory 208.

It should be appreciated that the pairing/binding process can be modified to accommodate a situation where the one-time registration is not explicitly performed by the primary user. In such a scenario, the binding instructions 228 may be configured to record the biometric information of the current user (e.g., fingerprints, facial scan, voice pattern, etc.) for a sufficient amount of time. The collection of biometric information from the current user can be leveraged to build the confidence that the user using the device is indeed the owner and then will establish a binding using the biometric information. When the binding is made, the AI module 260 may further add behavior data to the user's data models as long as the biometric information is still at a high enough confidence score to confirm the binding is still in place.

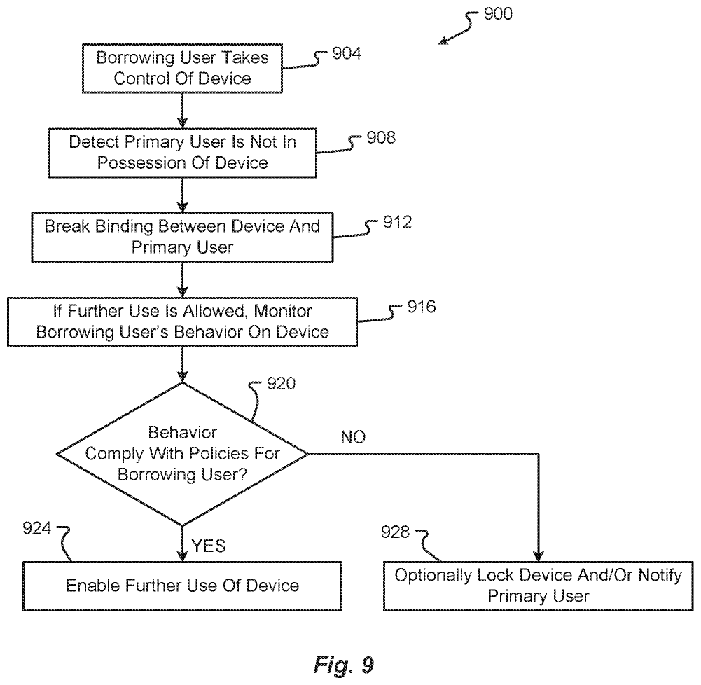

With reference now to FIG. 9, another method 900 of controlling the operation of a device 104, 108 will be described in accordance with at least some embodiments of the present disclosure. The method 900 begins when a borrowing user taking control of a device (step 904). This may occur with or without permission of the primary user and the borrowing user may correspond to a known and trusted borrowing user or an untrusted borrowing user.

The method continues with the binding instructions 228 determining that the primary user is not currently in possession of the device 104, 108 (step 908). This determination may be made by the binding instructions 228 alone or in combination with other instructions stored in memory 208 (e.g., activity monitoring instructions 240, biometric recording instructions 256, AI module instructions 260, etc.).

The method 900 then continues with the binding instructions 228 breaking the binding, to the extent one previously existed, between the primary user and the device (step 912). This may result in the compliance instructions 264 determining whether or not further use of the device is allowed by someone other than the primary user (step 916). In some embodiments, the compliance instructions 264 may determine that further use is allowed, but only so long as that further use is in alignment with compliance instructions 264 or other borrowing policies defined by the primary user.

The method 900 will then continue with the compliance instructions 264 determining whether the current behavior of the borrowing user is within alignment of the policies defined for the borrowing user (step 920). If the current behavior (e.g., use behaviors of the borrowing user) violate the compliance instructions 264, then the method will optionally lock the device, limit functionality of the device, and/or notify the primary user of the violations (step 928). On the other hand, if the query of step 920 is answered positively, then the borrowing user may be allowed to continue use of the device, so long as that further use is still in alignment with the compliance instructions 264 (step 924). It should be appreciated that the steps 920 and 924 may be continuously or iteratively performed to ensure that ongoing use of the device by the borrowing user is maintained within the compliance instructions 264. The present disclosure, in various aspects, embodiments, and/or configurations, includes components, methods, processes, systems, and/or apparatus substantially as depicted and described herein, including various aspects, embodiments, configurations embodiments, sub-combinations, and/or subsets thereof. Those of skill in the art will understand how to make and use the disclosed aspects, embodiments, and/or configurations after understanding the present disclosure. The present disclosure, in various aspects, embodiments, and/or configurations, includes providing devices and processes in the absence of items not depicted and/or described herein or in various aspects, embodiments, and/or configurations hereof, including in the absence of such items as may have been used in previous devices or processes, e.g., for improving performance, achieving ease and\or reducing cost of implementation.

The foregoing discussion has been presented for purposes of illustration and description. The foregoing is not intended to limit the disclosure to the form or forms disclosed herein. In the foregoing Detailed Description for example, various features of the disclosure are grouped together in one or more aspects, embodiments, and/or configurations for the purpose of streamlining the disclosure. The features of the aspects, embodiments, and/or configurations of the disclosure may be combined in alternate aspects, embodiments, and/or configurations other than those discussed above. This method of disclosure is not to be interpreted as reflecting an intention that the claims require more features than are expressly recited in each claim. Rather, as the following claims reflect, inventive aspects lie in less than all features of a single foregoing disclosed aspect, embodiment, and/or configuration. Thus, the following claims are hereby incorporated into this Detailed Description, with each claim standing on its own as a separate preferred embodiment of the disclosure.

Moreover, though the description has included description of one or more aspects, embodiments, and/or configurations and certain variations and modifications, other variations, combinations, and modifications are within the scope of the disclosure, e.g., as may be within the skill and knowledge of those in the art, after understanding the present disclosure. It is intended to obtain rights which include alternative aspects, embodiments, and/or configurations to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A communication system, comprising:
a communication device configured for use by a primary user and a borrowing user, wherein use of the communication device by the primary user is governed by primary user permissions, and wherein use of the communication device by a borrowing user is governed by borrowing user permissions; and
computer memory comprising a set of user binding instructions that, when executed by a processor, enable establishment of a binding relationship between the communication device and the primary user and, so long as the binding relationship between the communication device and the primary user is maintained, enable use of the communication device to be governed by the primary user permissions instead of the borrowing user permissions.

2. The communication system of claim 1, wherein the binding relationship between the communication device and the primary user is established and maintained in response to determining that the primary user has physical custody of the communication device and is currently interacting with a user interface of the communication device.

3. The communication system of claim 2, wherein the binding relationship is maintained on a continuous or periodic basis.

4. The communication system of claim 2, wherein the binding relationship is established in response to determining that an observed usage of the communication device matches at least one of a primary user biometric and behavior data model.

5. The communication system of claim 4, wherein the primary user behavior data model is stored as an artificial neural network or a derivative of the artificial neural network.

6. The communication system of claim 4, wherein the primary user behavior data model is updated in response to detecting ongoing user behavior that matches the primary user behavior data model with at least a predetermined confidence score.

7. The communication system of claim 6, wherein the predetermined confidence score required to update the primary user behavior data model is higher than a predetermined confidence score required to maintain the binding relationship between the communication device and the primary user.

8. The communication system of claim 1, wherein the set of user binding instructions, when executed by the processor, further enable the binding relationship to be broken in response to detecting at least one of a user biometric and behavior that falls outside of an expected behavior of the primary user.

9. The communication system of claim 8, wherein, in response to the binding relationship being broken, use of the communication device is governed by the borrowing user permissions which restrict at least one feature of function of the communication device from being used as compared to the primary user permissions.

10. The communication system of claim 10, wherein the set of user binding instructions, when executed by the processor, further enable a second binding relationship to be created and maintained in response to detecting a known borrowing user has physical custody of the communication device and is currently interacting with a user interface of the communication device.

11. A non-transitory computer readable medium comprising a set of instructions stored therein which, when executed by a processor, causes the processor to implement a device-to-user binding process by:
configuring a communication device for use by a primary user and a borrowing user, wherein use of the communication device by the primary user is governed by primary user permissions, and wherein use of the communication device by a borrowing user is governed by borrowing user permissions;
establishing a binding relationship between the communication device and the primary user;
monitoring ongoing use of the communication device;
based on the monitored ongoing use of the communication device, determining whether to maintain or break the binding relationship between the communication device and the primary user; and
enabling use of the communication device to be governed by the primary user permissions instead of the borrowing user permissions so long as the binding relationship between the communication device and the primary user is maintained.

12. The non-transitory computer readable medium of claim 11, wherein the borrowing user permissions comprise:
a first set of permissions that apply to known borrowing users of the communication device; and
a second set of permissions that apply to unknown borrowing users of the communication device.

13. The non-transitory computer readable medium of claim 12, wherein the second set of permissions govern use of the communication device when the binding relationship between the communication device and the primary user has been broken and when the monitored ongoing use of the communication device does not match at least one of a user biometric and behavior data model of a known borrowing user.

14. The non-transitory computer readable medium of claim 12, wherein the first set of permissions govern use of the communication device when the binding relationship between the communication device and the primary user has been broken and when the monitored ongoing use of the communication device matches a user behavior data model of a known borrowing user at least with a predetermined confidence score.

15. The non-transitory computer readable medium of claim 14, wherein the known borrowing user further comprises biometric data stored in association with the data model of the known borrowing user.

16. The non-transitory computer readable medium of claim 11, wherein the binding relationship between the communication device and the primary user is established and maintained in response to determining that the primary user has physical custody of the communication device and is currently interacting with a user interface of the communication device.

17. The non-transitory computer readable medium of claim 11, wherein the set of instructions further comprise a set of notification instructions that enable a notification message to be generated and sent to the primary user in response to determining that the binding relationship between the communication device and the primary user is broken.

18. A method, comprising:
configuring a communication device for use by a first primary user or a a second primary user;
establishing a binding relationship between the communication device and the first primary user in response to determining that the first primary user has physical custody of the communication device and is currently interacting with a user interface of the communication device;
determining whether to maintain or break the binding relationship between the communication device and the first primary user; and
enabling use of the communication device to be governed by first primary user permissions instead of second primary user permissions so long as the binding relationship between the communication device and the first primary user is maintained.

19. The method of claim 18, further comprising:
monitoring ongoing use of the communication device;
comparing the ongoing use of the communication device against one or more data models that define an expected behavior of the first primary user; and
determining that the binding relationship between the communication device and at least one of the first primary user and the second primary user is to be maintained when the comparison of the ongoing use of the communication device against the one or more data models satisfies the one or more data models with at least a predetermined confidence score.

20. The method of claim 18, further comprising:
modifying operation of the communication device by at least one of:
disabling one or more functions of the communication device in response to determining that the binding relationship between the communication device and at least one of the first primary user or the second primary user is broken; and
redirecting a borrowing user to a function other than a selected function.

21. The method of claim 18, wherein the first primary user corresponds to an adult user and wherein the second primary user corresponds to a minor user.
